(19) United States
(12) Patent Application Publication
(10) Pub. No.: US 2020/0327745 A1
(43) Pub. Date: Oct. 15, 2020

(54) HALF SHAFT SYSTEM

(71) Applicant: STEERING SOLUTIONS IP HOLDING CORPORATION, SAGINAW, MI (US)

(72) Inventors: James M. Petrowski, Saginaw, MI (US); Eduardo R. Mondragon-Parra, Freeland, MI (US); Jeffrey P. Courville, Frankenmuth, MI (US); Brian J. Kleinfeld, Saginaw, MI (US)

(21) Appl. No.: 16/382,568

(22) Filed: Apr. 12, 2019

(51) Int. Cl. G07C 5/08

(52) U.S. Cl. CPC G07C 5/085; G07C 5/0808

(57) ABSTRACT

A half shaft system includes first and second universal joints, a shaft, a torque sensor device, and computing circuitry. The shaft is engaged to, and extends between, the first and second universal joints. The shaft is adapted to rotate about an axis. The torque sensor device is attached to the shaft, and includes a torque sensor and a transmitter. The torque sensor is configured to measure torque placed upon the shaft. The transmitter is configured to wirelessly output torque signals indicative of the measured toque. The computing circuitry is configured to receive the torque signals, process the torque signals, establish a load history of the half shaft assembly from the processed torque signals, compare the load history to a pre-programmed life model, and estimate a service life of the half shaft assembly from the load history.

### BACKGROUND OF THE INVENTION

The present disclosure relates to a half shaft system, and more particularly, to a system configured to estimate useful life of a half shaft assembly of the system.

Half shaft assemblies are used in a wide variety of rotating, mechanical, applications including vehicles. A typical half shaft assembly includes first and second universal joints, and a shaft connected to and extending between the joints. In many applications, the universal joints are constant velocity (CV) joints. Over period of time, wear of the half shaft assembly occurs. This wear is a function of torque placed upon the half shaft assembly and the rotational speed of the assembly. This wear can be measured during maintenance activity. Unfortunately, such wear cannot be predicted prior to occurrence, thus any opportunity to prevent or limit wear is limited.

Accordingly, it is desirable to estimate remaining useful life of a half shaft assembly so that preparations can be made to extend the service life, or otherwise prepare for corrective action.

### SUMMARY OF THE INVENTION

These and other advantages and features will become more apparent from the following description taken in conjunction with the drawings.

In one exemplary, non-limiting, embodiment of the present disclosure, a half shaft system includes first and second universal joints, a shaft, a torque sensor device, and computing circuitry. The shaft is engaged to, and extends between, the first and second universal joints. The shaft is adapted to rotate about an axis. The torque sensor device is attached to the shaft, and includes a torque sensor and a transmitter. The torque sensor is configured to measure torque placed upon the shaft. The transmitter is configured to wirelessly output torque signals indicative of the measured toque. The computing circuitry is configured to receive the torque signals, process the torque signals, establish a load history of the half shaft assembly from the processed torque signals, compare the load history to a pre-programmed life model, and estimate a service life of the half shaft assembly from the load history.

In another embodiment, a half shaft system is configured to measure the life of a half shaft assembly that includes first and second constant velocity joints and a rotating shaft extending between the first and second constant velocity joints. The half shaft system includes a torque sensor device and computing circuitry. The torque sensor device is adapted to be attached to the shaft, and includes a torque sensor configured to measure torque placed upon the shaft and a transmitter configured to wirelessly output torque signals indicative of the measured toque. The computing circuitry is configured to receive the torque signals, process the torque signals, establish a load history of the half shaft assembly from the processed torque signals, compare the load history to a pre-programmed life model, estimate a service life of the half shaft assembly from the load history, and output a signal indicative of the estimated service life.

In another embodiment, a method of operating a half shaft system includes measuring torque by a torque sensor of a torque sensor device engaged to a rotating shaft of a half shaft assembly. A torque signal indicative of the measured torque is then transmitted wirelessly by a transmitter of the torque sensor device, and to a computing circuitry. Load history data is generated and stored in a storage medium of the computing circuitry from at least the torque signal. An application is executed by a processor of the computing circuitry that retrieves the load history data and a preprogrammed life model to determine the remaining useful life expectancy of the half shaft assembly.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic of a host vehicle illustrating a half shaft system;

FIG. 2 is a schematic of the half shaft system;

FIG. 3 is a partial flow chart of a method of operating the half shaft system;

FIG. 4 is the remainder of the flow chart of FIG. 3; and

FIG. 5 is a schematic of a second embodiment of a half shaft system.

### DETAILED DESCRIPTION

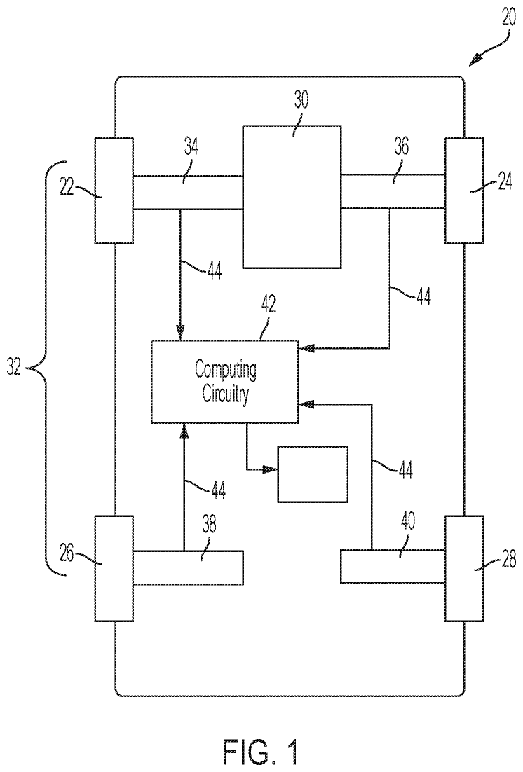

Referring now to the Figures, where the invention will be described with reference to specific embodiments, without limiting same, FIG. 1 shows a host vehicle 20 that includes front roadwheels 22, 24, rear roadwheels 26, 28, a powertrain 30 (e.g., combustion engine and transmission), and a half shaft system 32. As will be explained in detail, the half shaft system 32 is configured to determine a remaining useful life of at least one half shaft assembly of the system. This determination may then be disseminated to other systems of the vehicle, and/or externally for, in one example, vehicle maintenance support.

In one example, the half shaft system 32 includes at least one half axle assembly (i.e., four illustrated as 34, 36, 38, 40), and computing circuitry 42 configured to receive and process torque signals (see arrows 44) from each one of the half axle assemblies 34, 36, 38, 40. In one example, the host vehicle 20 may be a front wheel drive vehicle with a rear independent suspension. In this example, the half axle assemblies 34, 36 are rotationally driven by the powertrain 30, and are connected to and extends between the respective front roadwheels 22, 24 and the powertrain 30. The half axle assemblies 38, 40 are associated and rotationally operate in unison with a rear suspension (not shown). Alternatively, the host vehicle 20 may be a rear wheel drive vehicle, and/or a four wheel drive vehicle. It is further contemplated that the vehicle 20 utilizing at least one of the half axles may be any type of vehicle including marine, aviation, railway, and other vehicles.

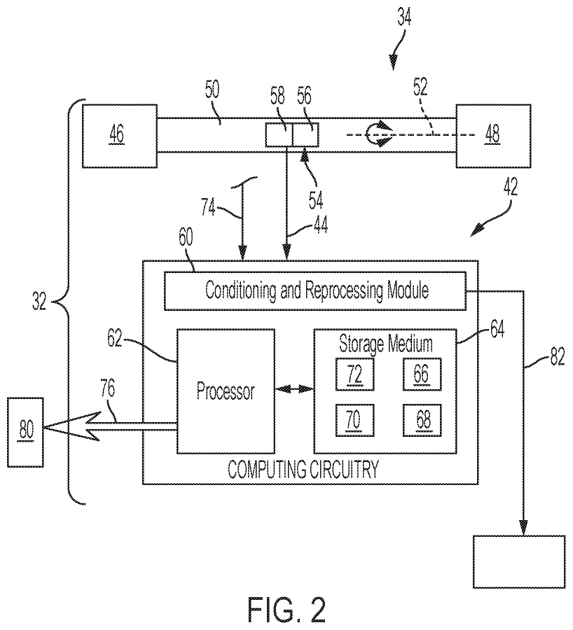

Referring to FIG. 2, it is understood that half axle assembly 34 is shown, however, the same description and/or elements exist for half axle assemblies 36, 38, 40. As illustrated, half axle assembly 34 includes first and second universal joints 46, 48, a shaft 50 rotationally extending along an axis 52, and a torque sensor device 54 attached to the shaft 50. Each torque sensor device 54 includes a torque sensor 56 (i.e., load sensor) and a transmitter 58 configured to wirelessly transmit torque measured by the torque sensor 56 as the torque signal 44 to the computing circuitry 42. In one embodiment, the transmitter 58 may be a transceiver. In one preferred example, the universal joints 46, 48 are constant velocity (CV) joints. In other embodiments, one or more of the universal joints may be Cardan joints, or others. In one example, the torque sensor 56 is a non-compliant torque sensor. In this, or another embodiment, the torque sensor device 54 may be self-energizing, thus capable of generating energy from the rotational motion of the shaft 50.

In one embodiment, the computing circuitry 42 of the half shaft system 32 includes a conditioning and pre-processing module 60 (e.g., electronic filter), one or more processors 62 (i.e., one illustrated), and one or more electronic storage mediums 64 (i.e., one illustrated) that may be computer writeable and readable. The storage medium 64 is configured to store load history data 66 (i.e., a load history file), a preprogrammed life model 68, a preprogrammed probability threshold 70, and an application 72 (i.e., executable instructions). In one example, the processor 62 is a microprocessor or other control circuitry such as analog and/or digital control circuitry including an application specific integrated circuit (ASIC) for processing data as is known by one with skill in the art. In one example, the storage medium 64 of the computing circuitry 42 is non-volatile memory, such as electrically erasable programmable read-only memory (EEPROM) for storing one or more routines, applications, thresholds, captured data, and preprogrammed data. In one example, the load history data 66, the preprogrammed life model 68, the preprogrammed probability threshold 70, and the application 72 are executed, or otherwise applied, by one or more of the processors 62 to enable operation, or functioning, of the half shaft system 32.

In one embodiment, the conditioning and pre-processing module 60 is configured to filter noise then discretize the filtered signal to a specific, pre-defined, format. The torque signal in one aspect, is a two-dimensional array including time and torque. However, once vehicle speed is introduced with additional torque signals the array becomes n-dimensional and is processed accordingly.

In one embodiment, the load history data 66 is a running history of load data as a function of measured torque and frequency. The frequency is indicative of rotational speed (i.e., revolutions per minute) of the half shaft assembly 34. In one embodiment, the frequency may be measured by the torque device 54, or in other embodiments, the frequency may be measured by other sensors of the vehicle at any variety of locations including the powertrain 30. Regardless, the measured frequency is sent to the computing circuitry 42 as a frequency signal (see arrow 74), is correlated to the torque signal 44 for any given moment in time, and becomes part of the load history data 66. The useful life expectancy, or remaining life expectancy, of the half shaft assembly 34 is dependent upon the wear of either universal joint 46, 48, and the wear of the shaft 50. The load history data 66 is reflective of the wear of the entire half shaft assembly 34.

In one example, the preprogrammed life model 68 is empirically established, and is specific to a particularly vehicle model. The preprogrammed life model 68 reflects that if the host vehicle 20 is driven aggressively at consistently high torque and frequency values, the useful life expectancy of any one of the half shaft assemblies 34, 36, 38, 40 will be shorter than a host vehicle driven in a relatively mild manner (i.e., lower torque and speeds).

The application 72 stored in the storage medium 64 is executed by the processor 62, and is configured to compare the current load history data 66 to the preprogrammed life model 68. The application 72 also applies the preprogrammed probability threshold 70 to the comparison study to establish a level of confidence of the end result. The results (i.e., remaining useful life of the half shaft assembly) of this comparison is then outputted as a signal (see arrow 76) to be received, for example, by other systems of the host vehicle 20. Examples of other systems include maintenance inquiry systems, traction control systems, systems configured to prolong the need for maintenance, user notification systems, and others.

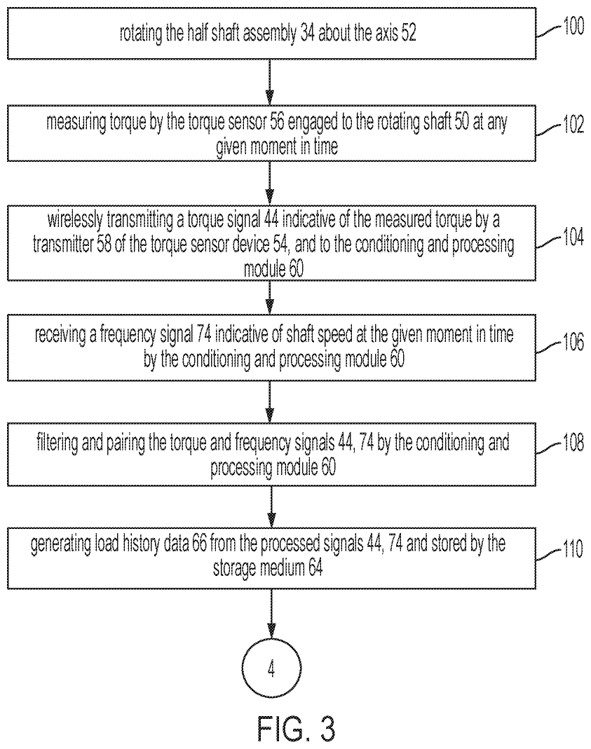

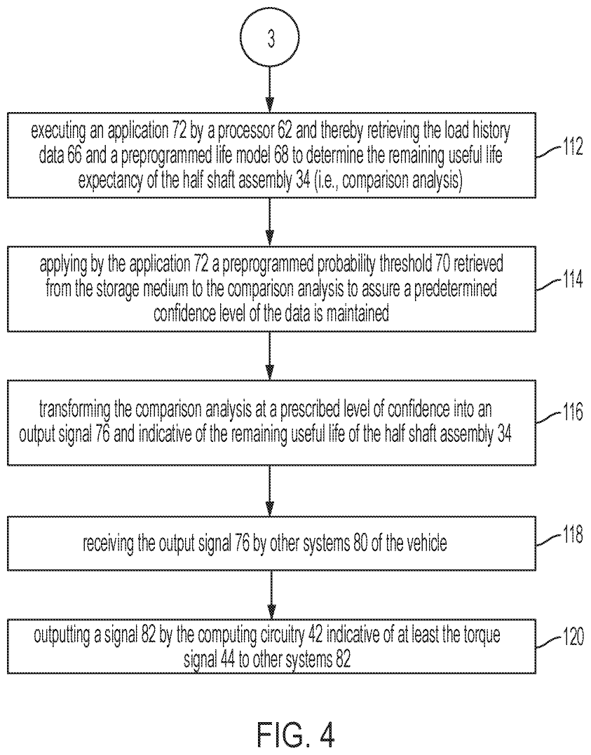

Referring to FIGS. 3 and 4, a method of operation includes, at block 100, rotating the half shaft assembly 34 about the axis 52. The torque sensor device 54 rotates with the shaft 50 of the half shaft assembly 34. At block 102, the torque sensor 56 measures the torque placed upon the rotating shaft 50 at any given moment in time. At block 104, a transmitter 58 of the torque sensor device 54 wirelessly sends the torque signal 44 indicative of the measured torque, to the conditioning and processing module 60. At block 106, and also at this moment in time, the frequency signal 74 is sent to the conditioning and processing module 60. At block 108, the conditioning and processing module 60 filters and generally pairs the incoming signals 44, 74.

At block 110, the load history data 66 is generated from the processed signals 44, 74 and stored by the storage medium 64. At block 112, the application 72 is executed by the processor 62 and thereby retrieves the load history data 66 and the preprogrammed life model 68 to determine the remaining useful life expectancy of the half shaft assembly 34 (i.e., comparison analysis). At block 114, the application 72 applies the preprogrammed probability threshold 70 to the comparison analysis to assure a predetermined confidence level of the data is maintained. At block 116, the processor 62 transforms and outputs the comparison analysis at a prescribed level of confidence as the output signal 76 indicative of the remaining useful life of the half shaft assembly 34. At block 118, the output signal 76 is received by other systems 80 of the vehicle.

In one embodiment, and at block 120, the computing circuitry 42 may also output a signal (see arrow 82 in FIG. 2) indicative of the processed torque and frequency signals 44, 74 to other systems 82. In one embodiment, the system 82 may be a traction control system. The traction control system 82 may be an open loop system, or a closed loop system. That is, traction control systems are configured to distribute differing torques to the roadwheels 22, 24, 26, 28 with the intent to eliminate slippage and/or improve vehicle stability. Torque distribution may be achieved by means of a locking differential, brake actuation, and/or a combination of both. Open loop does not need further feedback, and closed loop cycles and adjusts itself continuously.

In another embodiment, the half shaft system 32 may not include the universal joints 46, 48 and the shaft 50. Instead, the half shaft system 32 may include the computing circuitry 42 and the torque sensor device 54 adapted to be attached to the shaft 50.

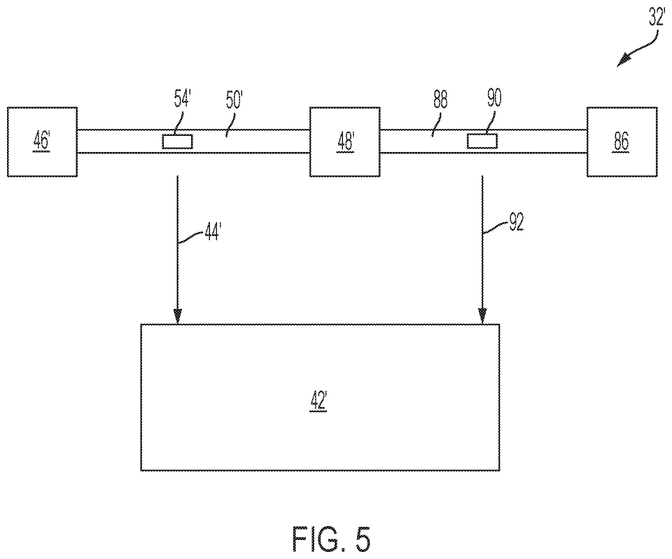

Referring to FIG. 5, another embodiment of the half shaft system is illustrated wherein like elements to the first embodiment have like identifying numerals except with the addition of a prime symbol suffix. In this embodiment, a half shaft system 32′ includes multiple half shaft assemblies 34′ arranged in series. More specifically, the half shaft assembly includes a first shaft 50′ connected to, and extending between, first and second universal joints 46′, 48′, a third universal joint 86, and a second shaft 88 extending between, and connected to, the second universal joint 48′ and the third universal joint 86. The half shaft system 32′ further includes a first torque sensor device 54′ engaged to the first shaft 50′, and a second torque sensor device 90 engaged to the second shaft 88. The torque sensor device 90 is configured to output a torque signal 92 to computing circuitry 42′.

In another embodiment, one or more of the universal joints 46, 48 may be Cardan joints. In yet another embodiment, the half shaft assembly, or portion thereof, may be part of a propshaft. For example, trucks typically include rigid axles and the torque measurement can be useful to predict the remaining useful life of the cardan joint in the propshaft and the remaining useful life of a differential. Other driveline configurations are also applicable.

The various functions described above may be implemented or supported by a computer program that is formed from computer readable program codes, and that is embodied in a non-transitory computer readable medium. Computer readable program codes may include source codes, object codes, executable codes, and others. Computer readable mediums may be any type of media capable of being accessed by a computer, and may include Read Only Memory (ROM), Random Access Memory (RAM), a hard disk drive, a compact disc (CD), a digital video disc (DVD), or other non-transitory forms.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A half shaft system comprising:
a first universal joint;
a second universal joint;
a shaft engaged to and extending between the first and second universal joints, the shaft being adapted to rotate about an axis;
a torque sensor device attached to the shaft, the torque sensor device including a torque sensor configured to measure torque placed upon the shaft and a transmitter configured to wirelessly output torque signals indicative of the measured toque; and
computing circuitry configured to receive the torque signals, process the torque signals, establish a load history of the half shaft assembly from the processed torque signals, compare the load history to a pre-programmed life model, and estimate a service life of the half shaft assembly from the load history.

2. The half shaft system set forth in claim 1, wherein the first and second universal joints are constant velocity joints.

3. The half shaft system set forth in claim 2, wherein the computing circuitry includes a processor and an electronic storage medium configured to store the pre-programmed life model and the load history, and an application executed by the processor to estimate the service life.

4. The half shaft system set forth in claim 3, wherein the computing circuitry includes a conditioning and pre-processing module configured to filter the torque signals.

5. The half shaft system set forth in claim 3, wherein a preprogrammed probability threshold stored in the electronic storage medium is applied by the application to establish a confidence level of the estimated service life.

6. The half shaft system set forth in claim 3, wherein the estimated service life is outputted by the computing circuitry as a notification.

7. The half shaft system set forth in claim 3, wherein a frequency signal indicative of the revolutions per minute of the shaft is received by the computing circuitry and included as part of the load history.

8. The half shaft system set forth in claim 7, wherein the load history and the pre-programmed life model are each a function of load and frequency over time.

9. The half shaft system set forth in claim 2, further comprising:
a third constant velocity joint;
a second shaft engaged to and extending between the second and third constant velocity joints, the second shaft being adapted to rotate about a second axis;
a second torque sensor device attached to the second shaft, the second torque sensor device including a torque sensor configured to measure torque placed upon the second shaft and a transmitter configured to wirelessly output torque signals indicative of the measured toque, and the computing circuitry configured to receive the torque signals from the second torque assembly.

10. The half shaft system set forth in claim 1, wherein the torque sensor is a non-compliant torque sensor.

11. The half shaft system set forth in claim 3, wherein the torque sensor is a non-compliant torque sensor.

12. The half shaft system set forth in claim 1, wherein the computing circuitry is configured to output the processed torque signals to a traction control system.

13. The half shaft system set forth in claim 12, wherein the traction control system is one of an open loop control system and a closed loop control system.

14. A half shaft system configured to measure the life of a half shaft assembly including first and second constant velocity joints and a rotating shaft extending between the first and second constant velocity joints, the half shaft system comprising:
a torque sensor device adapted to be attached to the shaft, the torque sensor device including a torque sensor configured to measure torque placed upon the shaft and a transmitter configured to wirelessly output torque signals indicative of the measured toque; and
computing circuitry configured to receive the torque signals, process the torque signals, establish a load history of the half shaft assembly from the processed torque signals, compare the load history to a pre-programmed life model, estimate a service life of the half shaft assembly from the load history, and output a signal indicative of the estimated service life.

15. The half shaft system set forth in claim 14, wherein the computing circuitry includes a processor and an electronic storage medium configured to store the pre-programmed life model and the load history, and an application executed by the processor to estimate the service life.

16. The half shaft system set forth in claim 15, wherein the computing circuitry includes a condition and pre-processing module configured to filter the torque signals.

17. The half shaft system set forth in claim 16, wherein a preprogrammed probability threshold stored in the electronic storage medium is applied by the application to establish a confidence level of the estimated service life.

18. The half shaft system set forth in claim 14, wherein a frequency signal indicative of the revolutions per minute of the shaft is received by the computing circuitry and included as part of the load history.

19. The half shaft system set forth in claim 14, wherein the torque sensor is a non-compliant torque sensor.

20. A method of operating a half shaft system comprising:
measuring torque by a torque sensor of a torque sensor device engaged to a rotating shaft of a half shaft assembly;
wirelessly transmitting a torque signal indicative of the measured torque by a transmitter of the torque sensor device, and to a computing circuitry;
generating load history data stored in a storage medium of the computing circuitry from at least the torque signal; and
executing an application by a processor of the computing circuitry and thereby retrieving the load history data and a preprogrammed life model to determine the remaining useful life expectancy of the half shaft assembly.
